(19) United States
(12) Patent Application Publication
(10) Pub. No.: US 2025/0288915 A1
(43) Pub. Date: Sep. 18, 2025

(54) SPATIAL AUDIO ADJUSTMENT SYSTEM FOR AN AMUSEMENT RIDE

(71) Applicant: Universal City Studios LLC, Universal City, CA (US)

(72) Inventors: Andrew Carbonar, Orlando, FL (US); Gregory Shellman Hall, Orlando, FL (US); William Rodriguez, Orlando, FL (US)

(21) Appl. No.: 18/608,516

(22) Filed: Mar. 18, 2024

(51) Int. Cl. A63G 31/16; G06F 3/16; H04R 5/02; H04R 5/04; H04S 7/00

(52) U.S. Cl. CPC A63G 31/16; G06F 3/165; H04R 5/02; H04R 5/04; H04S 7/303; H04S 2400/11

(57) ABSTRACT

A system for adjusting audio based on ride dynamics includes: a ride vehicle, a controller, one or more motion sensors, and one or more audio output devices coupled to the ride vehicle. The one or more motion sensors are configured to generate motion data of a guest and transmit the motion data to the controller. The controller is configured to receive the motion data and generate audio control instructions based at least on the motion data. The one or more audio output devices are configured to output a spatial audio signal based on the audio control instructions.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

The subject matter disclosed herein relates to amusement park attractions, and more specifically, to providing audial experiences in amusement park attractions.

Amusement parks or theme parks may include various entertainment attractions useful in providing enjoyment to guests of the amusement parks. For example, the attractions may include a ride attraction (e.g., closed-loop track, dark ride, thriller ride, or other similar ride), and the attraction may be part of a themed environment that may be traditionally established using equipment, furniture, building layouts, props, decorations, displayed media, and so forth. These themed environments may also incorporate sound using audio systems.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In accordance with an embodiment, a system for adjusting audio based on ride dynamics includes: a ride vehicle, a controller, one or more motion sensors, and one or more audio output devices coupled to the ride vehicle. The one or more motion sensors are configured to generate motion data of a guest and transmit the motion data to the controller. The controller is configured to receive the motion data and generate audio control instructions based at least on the motion data. The one or more audio output devices are configured to output a spatial audio signal based on the audio control instructions.

In accordance with another embodiment, a non-transitory computer-readable medium, the computer-readable medium including processor-executable code that when executed by a processor, causes the processor to receive simulated motion data of a guest during a ride cycle of an amusement ride. The processor-executable code, when executed by the processor, also causes the processor to generate audio control instructions based at least on the simulated motion data. Finally, the processor-executable code, when executed by the processor, causes the processor to transmit the audio control instructions to one or more audio output devices to cause the one or more audio output devices to output a spatial audio signal based on the audio control instructions.

In accordance with yet another embodiment, a method for adjusting spatial audio for an amusement ride includes receiving, via a processor, motion data of one or more guests during a ride cycle of the amusement ride from one or more motion sensors coupled to a ride vehicle. The method also includes generating, via the processor, audio control instructions based at least on the motion data. Further, the method includes transmitting, via the processor, the audio control instructions to one or more audio output devices configured to output a spatial audio output based on the audio control instructions.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of a system for adjusting audio based on ride dynamics, in accordance with present techniques;

FIG. 2 is a schematic illustration of the embodiment of FIG. 1 in which a guest is dynamically moving, in accordance with present techniques;

FIG. 3 is a schematic illustration of an embodiment of a system for adjusting audio based on ride dynamics for multiple guests in a ride vehicle, in accordance with present techniques;

FIG. 4 is a flow diagram of communication between devices of a spatial audio adjustment system, in accordance with present techniques;

FIG. 5 is a flow diagram of communication between devices of a spatial audio adjustment system using simulated motion data, in accordance with present techniques;

FIG. 6 is a flow diagram of a spatial audio adjustment method in accordance with present techniques; and

FIG. 7 is a block diagram of a spatial audio adjustment system including a ride vehicle and a ride controller, in accordance with present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

An amusement park may include an audio system to enhance a guest experience of an amusement park attraction, e.g., an amusement ride, show, or other experience, by providing guests with a themed sound environment. For example, the audio system may include speakers arranged in, on, or around a ride vehicle that accommodates one or more guests, and the audio system may output audio to supplement a physical, virtual reality, or augmented reality environment. In particular, the audio system may output spatial audio, creating a three-dimensional sound sensation for guests. In embodiments, spatial audio adjusts the sound directionality that can, for example, output audio from speakers to create an immersive 360 degree audio environment. In embodiments, sounds may be anchored to points in space so that, even when a guest turns their head, the sound origin point stays the same rather than turning with them. Stereo sound mixing separates sound into left and right channels, and spatial audio provides a height dimension to audio output, thus permitting forward/rear or above/below sound effects not typically rendered in two-channel stereo. In spatial audio, an audio output of individual audio objects is output over the speaker configuration. Depending on the desired audio effect, the audio associated with an individual object is distributed to the different speakers, e.g., the left speaker and the right speaker. Each audio object may have a different audio output.

Spatial audio may be developed based on a presumption of a position of a listener's left and right ear. Spatial audio outputs may, for example, be generated by emitting audio and recording or detecting the emitted audio using a pair of microphones attached to a model of the head of a listener. The detection of the emitted audio at the microphones provides data for modeling the audio experience at the left and right of the position of the listener. This method may effective in instances in which the head, and thus the ears, of a listener are presumed to remain static relative to the audio output device(s), such as when the listener is wearing headphones. However, in more dynamic environments, such as an attraction at an amusement park, recording and output of spatial sound environments proves challenging.

As an example, speakers may be attached to a ride vehicle seat that may move along a track of an amusement ride. While the ride vehicle moves along the track, forces may be exerted on the ride vehicle, the speakers, and one or more guests seated in the ride vehicle. In response to the forces, the one or more guests may move within the ride vehicle, changing the distance between each guest and the audio output devices, and thus changing the spatial audio experience of the one or more guests at one or both ears.

Accordingly, as will be described in more detail below, the present disclosure provides techniques to adjust a spatial audio output in order to provide an improved spatial audio experience for guests experiencing a particular attraction at an amusement park. A spatial audio adjustment system for an amusement ride may adjust a spatial audio output based on modeled and/or measured motion data, and the adjusted spatial audio output may thereby create an enhanced spatial audio environment for the guests. In particular, a spatial audio output, such as a themed spatial audio soundtrack, may be adjusted before or during an amusement ride to account motion, or presumed motion, of each guest relative to the speakers.

The spatial audio adjustment system may include one or more sensors configured to generate the motion data. The one or more sensors may include, for example, accelerometers, gyroscopes, inertial measurement units (IMUs), and the like, and may be attached or placed on or near the ride vehicle to generate the motion data. The motion data may include forces, accelerations, or other suitable measurements that may be useful in directly measuring or predicting a position of one or more guests relative to one or more audio output devices. For example, the motion data may indicate the ride vehicle is taking a turn to the right, which may indicate that the one or more guests will move to the left relative to the ride vehicle.

Additionally, the spatial audio adjustment system may include a controller that may generate audio control instructions based on the motion data, and the audio control instructions may include a motion-adjusted audio output. In particular, the controller may use the motion data to determine a distance between one or more guests and one or more audio output devices. Based on the determined distance, the controller may generate the audio control instructions to adjust an audio output (e.g., signal), and the motion-adjusted audio output may more accurately provide a spatial sound environment for the one or more guests. The audio control instructions may, for example, include instructions to increase or decrease an audio signal to one or more audio output devices (e.g., raise or lower a volume) when the ride vehicle is experiencing a sharp turn. In addition to the motion data, the controller may generate the audio control instructions based on other information, such as the height of one or more guests, calibration values indicated by one or more guests, and so on.

One or more guests experiencing a particular amusement ride may experience similar forces through the course of the particular amusement ride, and may, as a result, experience similar patterns of motion. Thus, in some embodiments, motion data generated during one iteration of the particular amusement ride may be used to generate motion-adjusted audio for subsequent iterations of the ride. Further, as will be described in more detail below, the spatial audio adjustment system may use simulation techniques to generate simulated motion data, and the simulated motion data may be used to generate the motion-adjusted audio output.

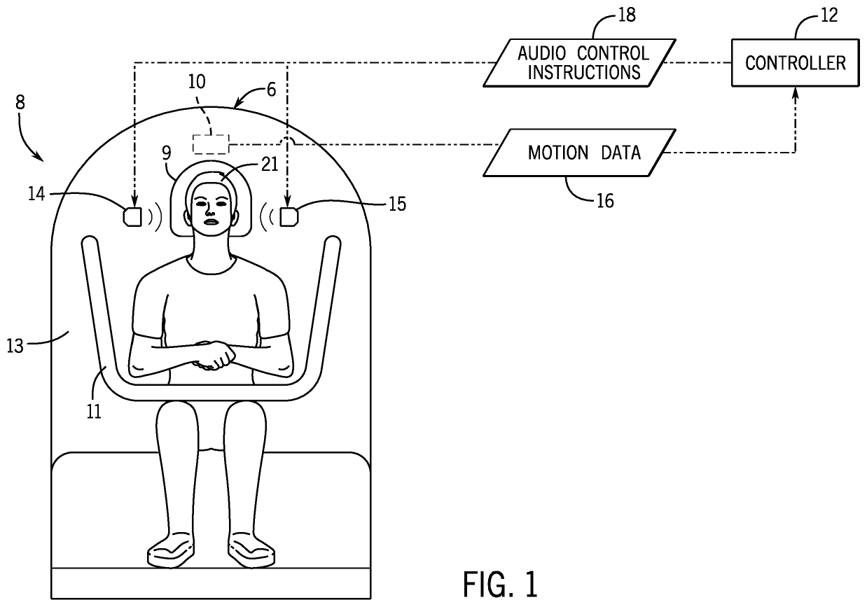

With the foregoing in mind, FIG. 1 illustrates a spatial audio adjustment system 8 including a controller 12 that generates audio control instructions 18 based on received motion data 16. The motion data 16 may be generated by one or more sensors 10 associated with the ride vehicle 13. By way of example, the one or more sensors 10 may be attached to or associated with a headrest 9 of a seat 6 of a ride vehicle 13. Audio control instructions may instruct one or more audio output devices 14, 15 to adjust an audio signal, and the one or more audio output devices 14, 15 may output the motion-adjusted audio output. In an embodiment, the one or more audio output devices may include one or more speakers.

In the illustrated embodiment, the one or more audio output devices 14, 15 are positioned to the left and right of a guest by way of example. In some embodiments, the one or more audio output devices 14, 15 may be coupled to, or part of, an upper portion of a restraint system 11, different portions of the seat 6, the restraint system 11, the headrest 9, or elsewhere on the ride vehicle 13. While two audio output devices 14, 15 are illustrated in FIG. 1, other arrangements of (e.g., 1, 3, 5, 10, or more) audio output devices may be present on the amusement ride or ride vehicle 13 and used as part of the spatial audio adjustment system 8. Further, as will be described in more detail below, one or more audio output devices may output an audio signal that may provide a spatial sound environment for a plurality (e.g., 2, 4, 8, or more) of guests.

In operation, the ride vehicle 13 may translate within the ride environment and/or may move along one or more degrees of freedom to exert forces on the seat 6 and a guest 21 that occupies the seat 6. Movement of the guest 21 may be tracked using the one or more sensors 10 to generate motion data 16 that may include an indication of a head position of the guest at various timepoints during the operation of the ride vehicle 13. The controller 12 may generate audio control instructions 18 based on the received motion data 16. In embodiments, the audio control instructions 18 may be generated dynamically in real-time for each individual guest 21 as the motion data 16 is received. In some embodiments, the motion data 16 may be collected and used as a calibration dataset to generate audio control instructions 18 for a representative guest 21 that experiences the attraction. For example, the calibration dataset may be used to generate audio control instructions for different, subsequent guests 21.

In an embodiment, motion data 16 is generated throughout an operating cycle of an amusement ride, e.g., a ride cycle of operation of the ride vehicle 13, and the set of motion data for the entire ride cycle is received and used as input to generate a reference set of the audio control instructions 18 by the controller. That is, the one more sensors 10 may generate the motion data 16 as part of a test or calibration cycle or cycles of the amusement ride, and the controller 12 may generate the audio control instructions 18 based on the motion data 16 that are executed during a subsequent ride cycle for subsequent guests 21 experiencing the amusement ride.

The audio control instructions 18 may, therefore, be stored in the system 8 and executed during each ride cycle. In such an embodiment, the motion data 16 may be motion tracking that estimates the position of a representative guest 21. Thus, the motion data 16 may be generated by a guest 21 or mannequin that is an average height. In embodiments, multiple different guests 21 occupying the seat 6 during different ride cycles are used to generate the motion data 16 of a representative guest 21, and the motion data 16 may be pooled or averaged to identify an average position of the left ear and the right ear at various time points during the ride cycle. The average position of the left ear and the right ear may in turn be used to generate the audio control instructions 18. As discussed herein, the left ear and/or right ear may move to different positions at different time points during the ride. Thus, the audio control instructions may account for movement of the left ear and/or right ear relative to the speakers during the ride.

Further, generation of motion data 16 may be included as part of a routine functional (e.g., operational, mechanical) calibration of the amusement ride, and thus may not necessitate further calibration of the amusement ride to generate the motion data 16. In an embodiment, individual motion data 16 is generated for each individual seat 6 of the ride vehicle 13. That is, for multi-seat ride vehicles 13, seats 6 on the ends may experience different forces relative to seats 6 positioned in a vehicle interior. The seats 6 on a left side, right side, front, and/or rear may experience different characteristic forces that are translated to their respective guests 21, resulting in different potential motion at each seat 6 and corresponding different motion data 16 resulting in per-seat audio control instructions 18.

In some embodiments, the one or more motion sensors 10 generate the motion data 16, the controller 12 generates the audio control instructions 18 based on the motion data 16, and the one or more audio output devices 14, 15 output an audio signal (e.g., a spatial audio signal) dynamically and in real-time while one or more guests are experiencing the amusement ride. That is, the spatial audio adjustment system adjusts a spatial audio output based on real-time feedback. This may additionally allow the controller 12 to generate audio control instructions based on real-time input, such as user calibration inputs.

In any case, the motion data 16 generated by the one or more motion sensors 10 may allow the controller 12 to determine, approximate, or predict the position of each of the one more guests 21 in the ride vehicle 13 relative to the one or more audio output devices 14, 15. In particular, the controller 12 may generate the audio control instructions 18 based on a determined and/or estimated position of the head and/or ears of each of the one or more guests 21. For example, the controller 12 may determine the guest head and/or ear position via an algorithm (e.g., machine learning algorithm) based on the sensor data that generates the motion data 16, and other suitable inputs. Ride simulation software may also be used as part of, or in conjunction with, the controller 12 to determine and/or estimate the position guest head and/or ear position. The motion data 16 may include a degree (e.g., scalar, factor, multiplier) of motion in addition to a direction of motion, and the controller 12 may determine the position based on the degree and the direction. In any case, the audio control instructions 18 may instruct the one or more audio output devices 14, 15 to adjust an audio signal (e.g., the spatial audio signal) based on the determined and/or estimated position relative to the one more audio output devices 14, 15.

In the illustrated embodiment of FIG. 1, the head of a guest 21 is generally equidistant between each of the one or more audio output devices 14, 15. As such, the audio control instructions sent to each audio output devices 14, 15 may cause each of the audio output devices 14, 15 to, for example, play at equal volumes. That is, if the position of the head of the guest 21 does not necessitate an adjustment the audio signal to maintain a spatial audio environment for the guest, the audio signal may not be adjusted based on motion. Additionally, the controller 12 may assume a default position (e.g., equidistant between each of the one or more audio output devices 14, 15) as the determined position in response to, for example, an initialization or system fault.

FIG. 1 illustrates audio control instructions 18 being sent to the one or more audio output devices 14. 15. In embodiments, the audio control instructions 18 may include multiple and/or different audio control instructions 18 that may be sent to the one or more audio output devices such that each audio output device may be independently addressed. For example, the controller 12 may send first audio control instructions to increase a volume to a first audio output device (e.g., audio output device 14), and the controller 12 may send second audio control instructions to decrease a volume to a second audio output device (e.g., audio output device 15). That is, each audio output device may be instructed independently by the controller 12, and the controller 12 may generate separate audio control instructions 18 for each of the one or more audio output devices. Further, while the illustrated embodiment shows left and right audio output devices 14, 15, audio output devices may be present at additional or alternate locations to provide other audio experiences. For example, the ride vehicle 13 may include front and/or rear speakers for each seat 6.

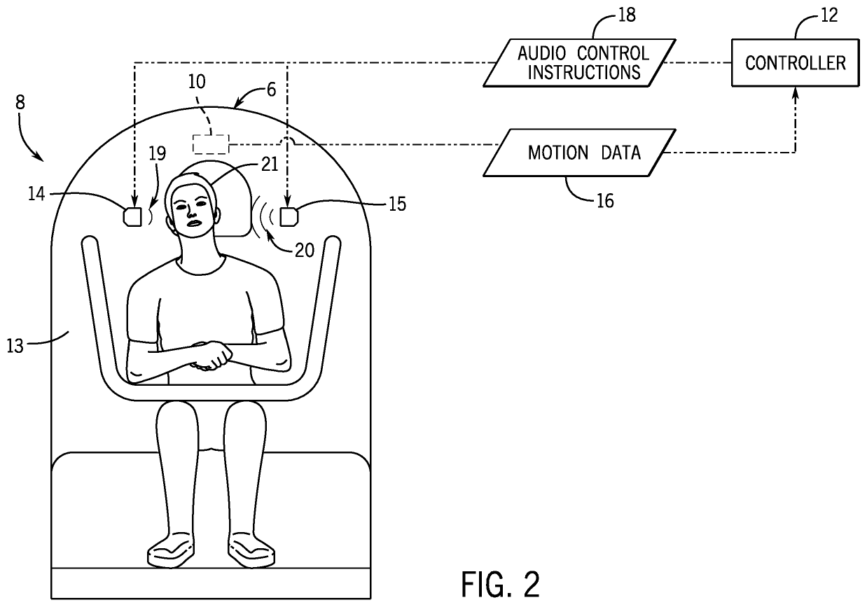

FIG. 2 illustrates an embodiment in which the controller 12 generates audio control instructions 18 based on a determined position of a guest, and in which the position of the guest is not equidistant between one or more audio output devices 14, 15. The motion data 16 may indicate, for example, that a ride vehicle is moving left. The controller 12 may, in response, determine that a head of a guest 21 may move to the right relative to seat 6 and/or the ride vehicle 13. The controller 12 may also determine, based on the motion data 16 and the determined position, that the head of a guest may be closer to the audio output device 14 than the audio output device 15 (e.g., the distance between the head of the guest 21 and the audio output device 14 is less than the distance between the head of the guest 21 and the audio output device 15). Based on the varying determined distances, the controller 12 may generate varying audio control instructions for each of the audio output devices 14, 15. As illustrated, the audio control instructions may cause the audio output device 14 to decrease an audio signal 19, and may cause the audio output device 15 to increase an audio output 20. The adjusted audio signals 19, 20 may simulate the audio output devices 14, 15 being equal distances from the head of the guest 21, allowing a spatial audio environment to be maintained.

While FIG. 2 illustrates the audio signals 19, 20 being generated based on adjustments made in response to the head of the guest moving to the right relative to the ride vehicle, other adjustments and other audio signals may be generated based on other presumed motions of the guest 21. For example, motion data 16 may indicate the guest moving to the left, upwards, downwards, forwards, backwards and so on relative to the ride vehicle 13 and or the ride seat 6. The controller 12 may determine a position of the head of the guest 21 accordingly (e.g., respectively), and may generate audio control instructions accordingly. The audio control instructions 18 may cause the audio output devices 14, 15 to direct sound towards the determined position via rotation of the audio output devices, volume level adjustments, or other suitable directional sound generation techniques.

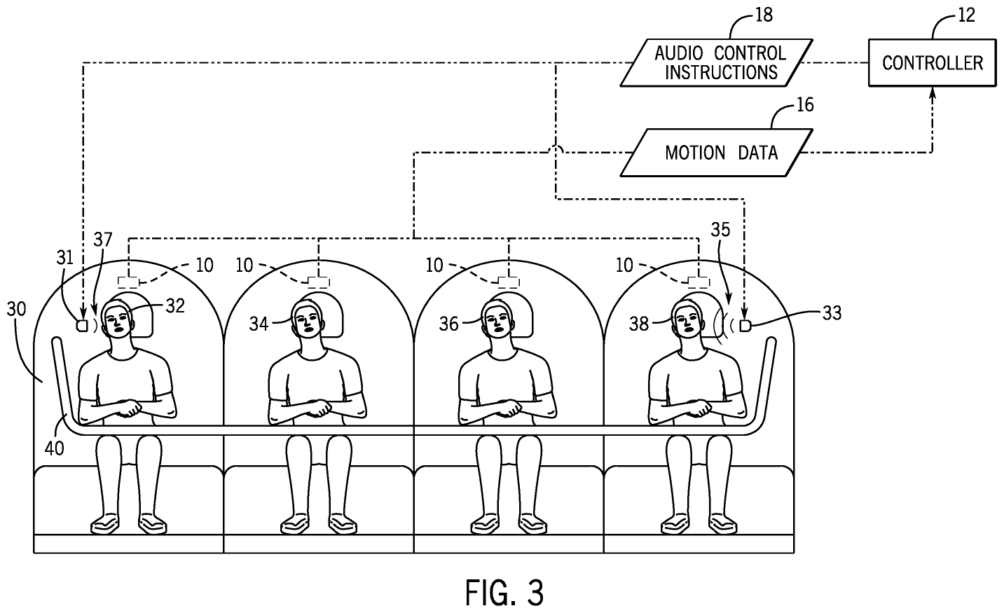

FIG. 3 illustrates a ride vehicle 30 containing a plurality of guests 32, 34, 36, 38, one more motion sensors 10, the controller 12, and one or more audio output devices 31 and 33. As illustrated, the one or more motion sensors 10 include 4 motion sensors that may be coupled to head rest portions of the ride vehicle 30 that may support the heads of each guest 32, 34, 36, and 38. The one or more motion sensors 10 may thus generate motion data 16 indicative of motion data associated with each of the guests 32, 34, 36, and 38. In the illustrated embodiment, the one or more audio output devices 31 and 33 are positioned to the left and right of the one or more guests 32, 34, 36, and 38. In one embodiment, the one or more audio output devices 31 and 33 may be positioned at an upper portion of a lap bar 40, and the lap bar 40 may restrain the plurality of guests 32, 34, 36, 38. As such, the one or more audio output devices 31 and 33 may provide a spatial audio environment, shown as outputs 35, 37, for each of the plurality of guests 32, 34, 36, and 38.

The motion data may vary between guests. For example, if the ride vehicle 30 is turning to the left (i.e., guest 38 is on the inside of the turn, and guest 32 is on the outside of the turn,) the motion data associated with the guest 38 and the motion data associated with the guest 32 may differ. Thus, the controller 12 may generate audio control instructions based at least on the differing motion data. The controller 12 may determine, for example, that a degree of motion associated with the guest 32 is greater than a degree of motion associated with the guest 38, and may determine the position of the guest 32 and the guest 38 based on the differing degree of motion. The controller 12 may then generate, for example, differing audio control instructions 18 based on the differing positions.

In other embodiments, fewer (e.g., 1, 2, or 3) or more (e.g., 5 or more) motion sensors 10 may be used to generate motion data associated with the plurality of guests 32, 34, 36, and 38. As such, different specificities (e.g., resolutions) of motion data 16 may be generated based on the quantity of motion sensors 10. Additionally, in some embodiments, the one or more motion sensors 10 of the ride vehicle 13 may generate motion data 16 associated with other guests on an amusement ride. For example, the one or motion sensors 10 may generate motion data associated with guests in rows behind, in front of, below, or above, the illustrated plurality of guests.

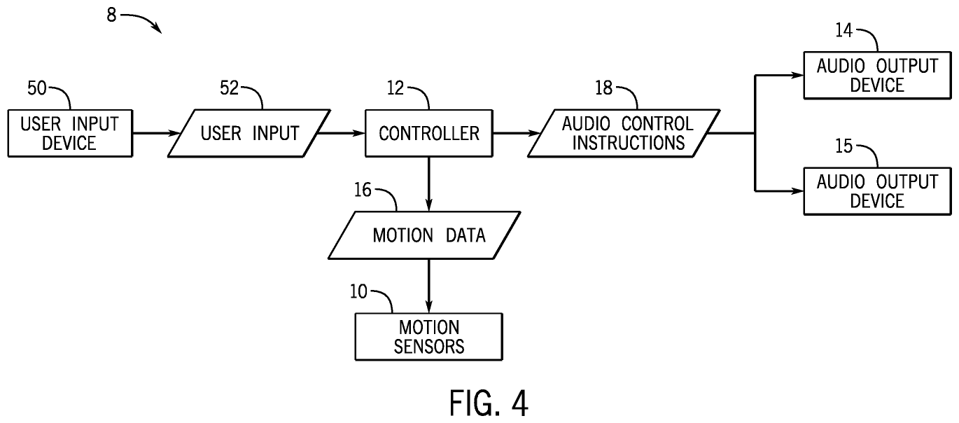

FIG. 4 shows communication pathways of a spatial audio adjustment system 8 between the one or more motion sensors 10, the controller 12, and the one or more audio output devices 14, 15. The one or more motion sensors 10 may generate motion data 16 using techniques described herein and transmit the motion data 16 to the controller 12. The controller 12 may generate audio control instructions 18 based on at least the motion data 16 using techniques described herein, and send the audio control instructions 18 to the one or more audio output devices 14, 15. It should be noted that while the one or more audio output devices 14, 15 are illustrated in FIG. 4, the illustrated communication pathways may be implemented with other audio output devices (e.g., audio output devices 15, 31, and/or 33) and/or different numbers of audio output devices.

In addition, a user input device 50 may generate user input 52 based on input from a guest of the amusement ride, and may send the user input 52 to the controller 12. The user input 52 may include, as examples, an indication of a height, weight, and/or audio preference of the guest. The user input device may include one or more buttons, sliders, graphical user interfaces (GUIs), and the like, and may be situated near a guest (e.g., within reach of a guest). As an example, the user input device 50 may include a slider coupled to a lap bar (e.g., the lap bar 11 of FIG. 1) that allows a guest (e.g., the guest 21) to control a volume output by the audio output device 14. The spatial audio adjustment may include one user input device for each guest in a ride vehicle of the amusement ride (e.g., the guests 32, 34, 36, and 38 of the ride vehicle 30), a user input device for multiple (e.g., a pair of) guests, multiple user input devices per guest, or any other suitable arrangement or quantity of user input devices.

In some embodiments, the user input 52 includes calibration data. For example, the user input 52 may be generated after, while, or in response to a prompt (e.g., audio cue) that is given to the guest. The controller 12 may instruct the audio output device 14 to output instructions for a guest to press a button of the user input device when a preferred spatial audio output is heard, and to then play a range of spatial audio outputs for the guest. The range may include, for example, spatial audio outputs with various balances between the one more audio output devices 14, 15, various volumes, various directionalities, and so on. As such, the guest may press the button of the user input device 50 when a preferred spatial audio output is heard. In response to the guest pressing the button of the user input device 50, user input 52 may be generated and sent to the controller 12 as calibration data, and the calibration data may include, for example, properties of a preferred spatial audio output.

The controller 12 may then generate audio control audio control instructions 18 based on the user input 52 in addition to, or in conjunction with, the motion data 16. As such, the audio control instructions 18 may include audio that is both motion-adjusted and calibrated for a guest, and the one or more audio output devices may output motion-adjusted and calibrated audio accordingly.

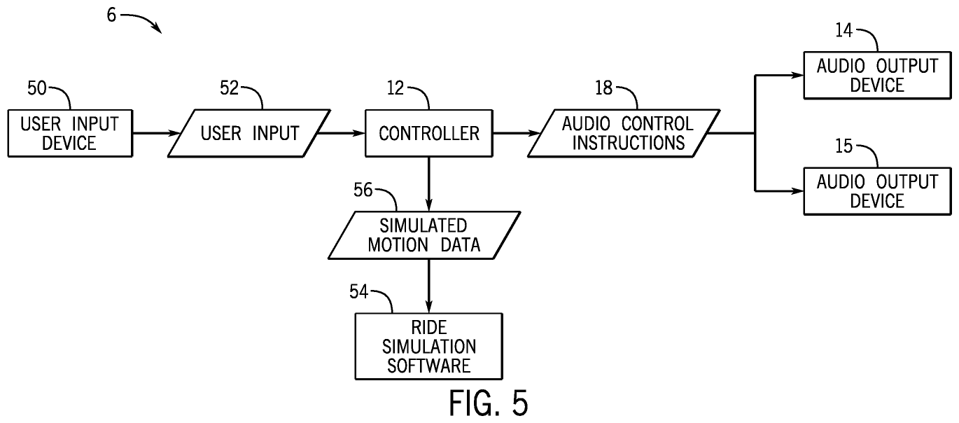

FIG. 5 shows communication pathways of a spatial audio adjustment system 8 between ride simulation software 54, the controller 12, and the one or more audio output devices 14, 15. The ride simulation software 54 may be used in place of, in addition to, or in conjunction with the one or more motion sensors 10 of the spatial audio adjustment system 8, for example. That is, the ride simulation software 54 may permit audio control instructions 18 to be provided based on a model of guest movement rather than or in addition to real-time sensed guest movement. Further, the simulated motion data 56 may be used in place of, in addition to, or in conjunction with the one or more motion sensors 10 of the spatial audio adjustment system 8.

The ride simulation software 54 may include any suitable ride simulation program capable of generating simulated motion data of an amusement ride, a ride vehicle of an amusement ride, guests in a ride vehicle, and so on. The simulated motion data 56 may be stored in a memory or storage of the controller, and may allow the controller 12 to determine, approximate, or predict the position of each of the one more guests 21 in the ride vehicle relative to the one or more audio output devices 14, 15. The simulated motion data 56 may characterize forces experienced by a guest or ride vehicle throughout the course of an amusement ride. For example, the simulated motion data 56 may include state representations (e.g., positions, velocities, accelerations) of a guest or ride vehicle, dynamics equations defining a change in the state representations, integration methods for the dynamics equations, motion constraints (e.g., of an anatomy of a guest), and/or environmental factors associated with a guest or ride vehicle. In particular, the controller 12 may generate audio control instructions 18 based on a determined position of the head and/or ears of each of the one or more guests based on the simulated motion data 56. For example, the controller 12 may determine the position via an algorithm (e.g., machine learning algorithm) based on a previous determined position, the simulated motion data 56, and other suitable inputs.

In some embodiments, the simulated motion data 56 may be generated based on motion data acquired during a testing procedure of the amusement ride. For example, motion sensors (e.g., the one or more motion sensors 10) may be placed on or near a model (e.g., mannequin, dummy) representative of a guest situated in a ride vehicle. As the ride vehicle moves along a track of the amusement ride, forces may be exerted on the model that may cause the model to move within the ride vehicle. Movement of the model may be acquired by the motion sensors as simulated motion data 56 that may be used to predict the motion of a (real) guest during a live ride cycle. In an embodiment, simulated motion data acquired throughout a testing procedure may be compiled as a ride simulation model that may be used to predict the position of a guest throughout a ride cycle.

In some embodiments, the controller 12 may receive the motion data 16 from the one or more motion sensors 10 and the simulated motion data 56 from the ride simulation software 54. The controller 12 may then generate the audio control instructions 18 based on either or both of the motion data 16 and the simulated motion data 56. In an example, the controller 12 may determine that the one or more motion sensors 10 are producing late, inaccurate, or otherwise insufficient motion data 16 and may instead generate the audio control instructions 18 based on the simulated generated motion data 56. The controller 12 may also use the motion data 16 to supplement the simulated motion data 56 to generate the audio control instructions 18. For example, the controller 12 may generate the audio control instructions 18 based on the simulated motion data 56 unless the controller 12 receives motion data 16 from the one or more motion sensors 10 that conflicts with the simulated motion data 56. In such a case, the controller 12 may default to the motion data 16 to generate the audio control instructions 18 or may use a combination of the motion data 16 and the simulated motion data 56 to generate the audio control instructions 18.

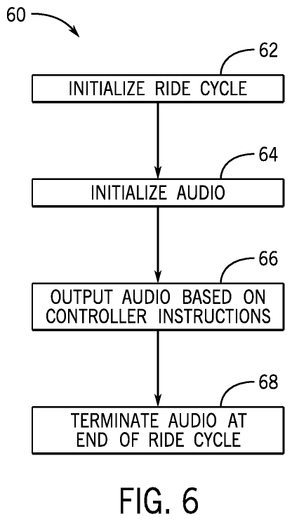

FIG. 6 is a flowchart of a method 60 for adjusting spatial audio based on ride dynamics and is discussed with reference to FIG. 1-5. The process begins with initializing a ride cycle (block 62). Initializing the ride cycle may include, for example, the controller 12 receiving user input 52, calibration data, motion data 16, and/or simulated motion data 56. Initializing the ride may also include other tasks associated with amusement ride, such as routine mechanical inspections, activating guest restraints, outputting safety information via the audio output devices 14, 15, and so on. When the controller initializes the ride cycle (block 62), it may initialize a spatial audio (block 64). Initializing the spatial audio may include, for example, generating audio control instructions 18 based on the user input 52, motion data 16, and/or simulated motion data 56, using techniques described herein. The audio control instructions may be generated for the duration of the ride prior to the ride beginning, or may be generated in real-time. In any case, the controller may send the audio control instructions 18 to the audio output devices 14, 15, and the audio output devices may output the spatial audio based on the audio control instructions 18 (block 66). When the cycle of the amusement ride is complete, the spatial audio may be terminated (block 68). This may involve resetting the user input 52, the motion data 16, and/or the simulated motion data 56 in preparation for a different guest 21. It may also include the audio output devices 14, 15 outputting additional safety information or exit instructions.

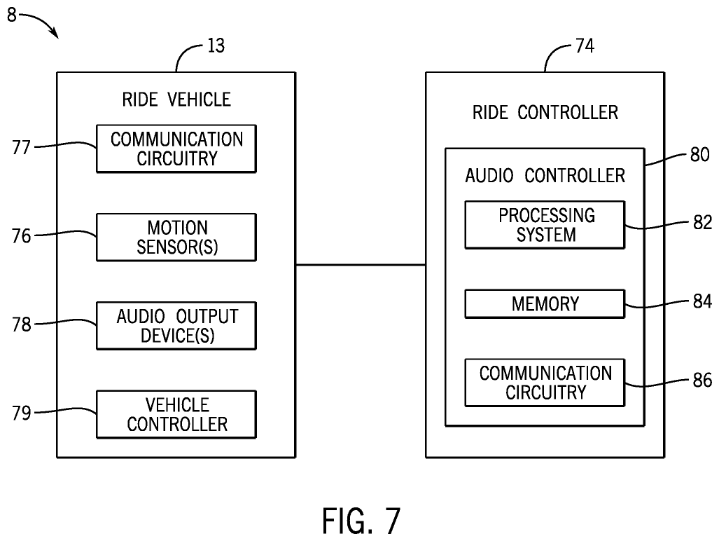

FIG. 7 illustrates of a block diagram of a spatial audio adjustment system 8 including a ride vehicle 13 communicatively coupled to a ride controller 74. The ride vehicle 13 may include, for example, the ride vehicle 13 of FIG. 1 or the ride vehicle 30 of FIG. 3. The ride vehicle 13 may include motion sensors 76, which may represent, for example, the motion sensor 10 of FIG. 1. The ride vehicle may also include communication circuitry 77, audio output devices 78, such as the audio output devices 14, 15 of FIG. 1 or the audio output devices 31 and 33 of FIG. 3, and a vehicle controller 79.

In an embodiment, the one or more sensors 76, 10 may include a camera, pressure sensors, capacitive sensors, tracking sensors, inertial measurement units, and/or optical sensors. In embodiments in which a camera is used, the camera may be a visible light camera and/or an IR camera. The one or more sensors 76, 10 may be mounted on the ride vehicle 13, the seat 6, and/or may be positioned in an environment of the attraction.

The ride controller 74 may include, or be used in conjunction with, an audio controller 80 (such as the controller 12 of FIG. 1). The ride controller 74 may facilitate, for example, control functions for the mechanical components of an amusement ride, such as lifts, magnets, lap bars, and harnesses. The audio controller 80 may include, for example, processing circuitry 82, a memory 84, and a communication component 86, and may facilitate generation and/or adjustment of a spatial audio output. The processing circuitry 82 may include one or more suitable processors that can execute instructions for carrying out the presently disclosed techniques, such as a general-purpose processor, system-on-chip (SoC) device, an application-specific integrated circuit (ASIC), a processor of a programmable logic controller (PLC), a processor of an industrial PC (IPC), or some other similar processor configuration. These instructions are encoded in programs or processor-executable code stored in a tangible, non-transitory, computer-readable medium. The memory 84 may include one or more storage devices, and may store machine-readable and/or processor-executable instructions (e.g., firmware or software) for the processing circuitry 82 to execute, such as instructions relating to determining guest motion from captured sensor data, such as a camera image. As such, the memory 84 may store, for example, control software, look up tables, configuration data, and so forth. The memory 84 may include a tangible, non-transitory, machine-readable-medium, such as a volatile memory (e.g., a random access memory (RAM)) and/or a nonvolatile memory (e.g., a read-only memory (ROM), flash memory, hard drive, and/or any other suitable optical, magnetic, or solid-state storage medium). The memory 84 may store user input, calibration data, motion data, simulated motion data, and so on. The memory 84 may also store instructions to adjust a spatial audio output, and the processing circuitry 82 may execute the instructions.

In some embodiments, the ride controller 74 may include the audio controller 80. In other embodiments, the audio controller 80 may be communicatively coupled to and separate from the ride controller 74. That is, in an embodiment, the ride controller 74 may facilitate control functions for ride control and spatial audio adjustment for the amusement ride. As such, the ride controller 74 may use the processing circuitry 82 for such control function and/or may have additional processing circuitry. The communication circuitry 77, 86 facilitates wireless (e.g. ethernet, WAN, and the like) and/or wired (HDMI, USB, and so forth) communication between the ride vehicle 13 and the ride controller 74 (and, in embodiments, the audio controller 80).

Execution of the audio control instructions 18 by the audio controller 80 may include accessing the audio control instructions 18 from the memory 84 and communicating the audio control instructions 18 to the ride vehicle 13 to change the audio output from the audio output devices 78 for spatial audio. For example, an audio distribution (e.g., between left, right, forward, and/or rear speakers) of a signal associated with a particular audio effect, such as a plane flying overhead, can be changed based on measured or predicted guest movement.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A spatial audio adjustment system for an amusement ride, comprising:
a ride vehicle;
one or more motion sensors coupled to the ride vehicle and configured to generate motion data of a guest during a ride cycle of the amusement ride;
a controller configured to:
receive the motion data;
generate audio control instructions based at least on the motion data; and
one or more audio output devices coupled to the ride vehicle and configured to:
output a spatial audio signal based on the audio control instructions.

2. The spatial audio adjustment system of claim 1, wherein the one or more audio output devices comprise a left speaker and a right speaker.

3. The spatial audio adjustment system of claim 2, wherein the audio control instructions change an audio distribution between the left speaker and the right speaker based on the motion data being indicative of the guest changing position relative to the left speaker and the right speaker during the ride cycle.

4. The spatial audio adjustment system of claim 1, wherein the spatial audio signal is output during the ride cycle.

5. The spatial audio adjustment system of claim 1, wherein the spatial audio signal is output during a subsequent ride cycle, and wherein the motion data is used to predict guest movement during the subsequent ride cycle.

6. The spatial audio adjustment system of claim 1, comprising one or more user input devices configured to accept user input of the guest, and wherein the controller is configured to:
receive the user input from the one or more user input devices; and
generate the audio control instructions based on the user input.

7. The spatial audio adjustment system of claim 6, wherein the user input comprises an indication of a height of the guest, a spatial audio preference of the guest, or both.

8. The spatial audio adjustment system of claim 6, wherein the one or more user input devices comprise buttons, sliders, graphical user interfaces (GUIs), or a combination thereof.

9. The spatial audio adjustment system of claim 6, wherein the one or more audio output devices are configured to output a calibration audio signal, and wherein the user input comprises calibration data responsive to the calibration audio signal.

10. A non-transitory computer-readable medium, the computer-readable medium comprising processor-executable code that when executed by a processor, causes the processor to:
receive simulated motion data of a guest during a ride cycle of an amusement ride;
generate audio control instructions based at least on the simulated motion data; and
transmit the audio control instructions to one or more audio output devices to cause the one or more audio output devices to output a spatial audio signal based on the audio control instructions.

11. The non-transitory computer-readable medium of claim 10, wherein the simulated motion data comprises a model of movements of the guest during the ride cycle.

12. The non-transitory computer-readable medium of claim 11, wherein the model comprises simulation of forces experienced by the guest during the ride cycle.

13. The non-transitory computer-readable medium of claim 10, wherein the one or more audio output devices comprise a left speaker and a right speaker.

14. The non-transitory computer-readable medium of claim 13, wherein the audio control instructions change an audio distribution between the left speaker and the right speaker based on the simulated motion data being indicative of the guest changing position relative to the left speaker and the right speaker during the ride cycle.

15. The non-transitory computer-readable medium of claim 10, wherein the processor-executable code, when executed by the processor, causes the processor to:
receive motion sensor data of the guest during the ride cycle of the amusement ride from one or more motion sensors coupled to a ride vehicle; and wherein:
the audio control instructions are generated based on the motion sensor data and the simulated motion data.

16. A method for adjusting spatial audio for an amusement ride, comprising:
receiving, via a processor, motion data of one or more guests during a ride cycle of the amusement ride from one or more motion sensors coupled to a ride vehicle;
generating, via the processor, audio control instructions based at least on the motion data; and
transmitting, via the processor, the audio control instructions to one or more audio output devices configured to output a spatial audio output based on the audio control instructions.

17. The method of claim 16, wherein the one or more audio output devices comprise one or more speakers coupled to the ride vehicle.

18. The method of claim 17, wherein the audio control instructions change an audio distribution between the one or more speakers based on the motion data being indicative of the one or more guests changing position relative to the one or more speakers during the ride cycle.

19. The method of claim 16, wherein the motion data of the one or more guests comprises respective motion data for each of the one or more guests.

20. The method of claim 19, wherein generating the audio control instructions based at least on the motion data comprises generating respective audio control instructions for each of the one or more guests based at least on the respective motion data.
